(19) United States
(12) Patent Application Publication
(10) Pub. No.: US 2026/0320001 A1
(43) Pub. Date: Oct. 15, 2026

(54) SCALING LOG DATA PROCESSING BEYOND A LOG INDEX WITH DYNAMIC HELPERS SUPPORTING THE SAME LOG INDEX

(71) Applicant: Oracle International Corporation, Redwood Shores, CA (US)

(72) Inventors: Bo Zou, Seattle, WA (US); Shushuai Zhu, Nashua, NH (US)

(73) Assignee: Oracle International Corporation, Redwood Shores, CA (US)

(21) Appl. No.: 19/178,199

(22) Filed: Apr. 14, 2025

(51) Int. Cl. G06F 16/17

(52) U.S. Cl. CPC G06F 16/1734

(57) ABSTRACT

Techniques for processing log data items for a log index using multiple queues for processing and storing information from the log data items to multiple different storage systems are provided. A log processing system accesses a queue of log data items mapped to a log index, and detects that log data items are being added to the queue faster than processing of log data items from the queue. Based at least in part on the detecting, the log processing system activates a separate queue for the same log index. The separate queue is supported by other log processing instance(s) that are configured to process the separate queue's log data items and store sets of resulting information to a second storage system. The log processing system also stores an indication that data having characteristic(s) is stored across both the first storage system and the second storage system.

### BACKGROUND

Even small computing systems perform too many operations for a person to manually track results of the operations. For small and large computing systems, both local and distributed, log messages serve as a stored indication of what occurred in a software system at a particular time. The log messages may be generated as the computing systems perform tasks. Log messages themselves may be too numerous for raw human consumption even in small computing systems due to the high number of operations and events that may be occurring every second. For this reason, log analysis systems may help users analyze large sets of log data to determine which log messages are most important to issues being experienced by the users.

Log analysis systems allow users to search log data that has been parsed and indexed for searching, but the process of parsing and indexing log data can be cumbersome and expensive for large volumes of log data. Even for highly performant log processing systems with large CPU and memory limits, the number of log messages streaming into the log processing system may be too much for the log processing system to handle. As a result, the log processing system may provide search results and analysis for the log data that has been parsed and indexed without providing search results and analysis for log data that is yet to be processed. If a user issue relates to unprocessed or unindexed log data, the log data returns to being of limited use to the user due to the difficulty of knowing where to find relevant information in the vast volume of log data.

### BRIEF SUMMARY

Systems, methods, and computer-readable media are provided for processing log data items for a log index using multiple queues for processing and storing information from the log data items to multiple different storage systems. A log processing system accesses a queue of log data items mapped to a log index. The log processing system detects that log data items are being added to the queue faster than log processing instances supporting the queue are processing log data items from the queue into sets of information for storage in a first storage system. Based at least in part on the detecting, the log processing system activates a separate queue for the same log index. The separate queue is supported by other log processing instance(s) that are configured to process the separate queue's log data items and store sets of resulting information to a second storage system that is shared by the other log processing instance(s) but not by the log processing instances supporting the queue. The log processing system also stores an indication that data having characteristic(s) is stored across both the first storage system and the second storage system.

In some embodiments, a computer-implemented method includes accessing a queue comprising log data items having at least one of one or more characteristics associated with a log index. At least one of the queue's log data items are processed by log processing instances that are configured to process the queue's log data items at least in part by extracting information from the queue's log data items. Sets of information determined from the at least one of the queue's log data items are stored by the log processing instances to first storage shared by the log processing instances. The computer-implemented method further includes detecting that log data items are being added to the queue faster than the log processing instances are processing log data items from the queue. Based at least in part on the detecting, the computer-implemented method includes activating a separate queue for the log index. One or more other log processing instances are configured to process the separate queue's log data items at least in part by extracting information from the separate queue's log data items. While the separate queue is active, the computer-implemented method includes adding, to the separate queue for the log index, one or more particular log data items having at least one of the one or more characteristics associated with the log index. The computer-implemented method further includes, while the separate queue is active, processing, by the one or more other log processing instances, at least one of the one or more particular log data items from the separate queue. The computer-implemented method further includes, while the separate queue is active, storing, by the one or more other log processing instances, one or more particular sets of information determined from the at least one of the one or more particular log data items to second storage shared by the one or more other log processing instances but not by the one or more log processing instances. The computer-implemented method further includes, while the separate queue is active, storing an indication that data having at least one of the one or more characteristics is stored across both the first storage and the second storage.

In a further embodiment, the first storage is partitioned based on times determined from the at least one of the queue's log data items associated with the sets of information, and the second storage is partitioned based on times determined from the at least one of the one or more particular log data items associated with the particular sets of information. The computer-implemented method further includes accessing a request for data corresponding to one or more particular times, and determining, based at least in part on the stored indication, that the first storage covers at least one of the one or more particular times and that the second storage covers at least one of the one or more particular times. The computer-implemented method further includes requesting data from both the first storage and the second storage responsive to the request.

In the same or a different further embodiment, the computer-implemented method includes detecting that log data items are being added to queues, including the queue and the separate queue, faster than active log processing instances, including the log processing instances and the one or more other log processing instances, are processing log data items from the queues. Based at least in part on the detecting that log data items are being added to queues faster than active log processing instances are processing log data items from the queues, the computer-implemented method includes activating another separate queue to handle part of a load of incoming log data items having at least one of the one or more characteristics associated with the log index.

In the same or a different further embodiment, the computer-implemented method includes detecting that a backlog of unprocessed log data items in the queue has cleared, and de-activating the separate queue based at least in part on detecting that the backlog of unprocessed log data items in the queue has cleared.

In the same or a different further embodiment, the computer-implemented method includes randomly selecting from among queues comprising the queue and the separate queue for assignment of a new log data item, and de-activating the separate queue when a length of the separate queue exceeds a threshold.

In the same or a different further embodiment, the computer-implemented method includes determining that a length of a de-activated separate queue satisfies a lower threshold. In response, the computer-implemented method includes re-activating the de-activated separate queue for processing log data items.

In the same or a different further embodiment, the computer-implemented method includes re-assigning a set of log data items from the queue to the separate queue based at least in part on a length of the queue and a length of the separate queue.

In the same or a different further embodiment, the computer-implemented method includes determining a number of separate queues to activate based at least in part on a log processing bandwidth and incoming rates of log data items.

In the same or a different further embodiment, the one or more other log processing instances include two or more log processing instances that are further configured to share third storage for log data items that originated before a threshold time, and the two or more log processing instances share the second storage for log data items that originated after the threshold time.

In the same or a different further embodiment, the steps of accessing the queue, detecting that log data items are being added to the queue faster than the log processing instances are processing log data items from the queue, activating the separate queue, adding the particular log data items, processing the particular log data items, storing particular sets of information, and storing the indication are separately performed by a multi-tenant log processing system for each of a plurality of sub-tenant log data partitions of a plurality of tenants of the multi-tenant log processing system. The computer-implemented method further includes accessing a Kafka message for a bundle of log messages corresponding to the log index. The computer-implemented method further includes assigning the bundle of log messages to the separate queue. The computer-implemented method further includes processing the bundle of log messages from the separate queue. The computer-implemented method further includes storing results of processing the bundle to the second storage; wherein the first storage comprises a first Solr Core Group and the second storage comprises a second Solr Core Group.

In the same or a different further embodiment, the log processing instances are configured to extract information from the queue's log data items at least in part by parsing the queue's log data items using log parsers selected from a plurality of log parsers based on detected message patterns of a plurality of candidate message patterns. The one or more other log processing instances are configured to extract information from the separate queue's log data items at least in part by parsing the separate queue's log data items using log parsers selected from a plurality of log parsers based on detected message patterns of a plurality of candidate message patterns.

In the same or a different further embodiment, the detecting is a second step of detecting, and the computer-implemented method further includes activating at least one of the log processing instances that are configured to process the queue's log data items based at least in part on a first step of detecting that log data items are being added to the queue faster than one or more log processing instances are processing log data items from the queue.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory and/or transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items or separate process instances of a set of process instances. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that processes log data items for a log index using multiple queues for processing and stores information from the log data items to multiple different storage systems.

FIG. 2 illustrates a system diagram showing an example system architecture configured to process log data items for a log index using multiple queues for processing and store information from the log data items to multiple different storage systems.

FIG. 3 illustrates a diagram of an example user interface showing analysis of log data items that may include log data items retrieved from different storage systems.

FIG. 4 illustrates a diagram of an example system that processes information from log data items to a storage system associated with a log index.

FIG. 5 illustrates a diagram of an example system that processes information from log data items to different storage systems each associated with the same log index but with a different log index helper.

FIG. 6 illustrates a diagram of an example system that controls different log index helpers for processing information from log data items associated with the same log index.

FIG. 7 illustrates a diagram of an example system that reassigns log data items from a main queue to separate queues for processing information from the log data items to different storage systems.

FIG. 8 illustrates a diagram of an example system that processes information from log data items to different storage systems for old data and for recent data, as well as different storage systems for log index helpers and for the main log index.

FIG. 9 depicts a simplified diagram of a distributed system for implementing certain aspects.

FIG. 10 is a simplified block diagram of one or more components of a system environment by which services provided by one or more components of an embodiment system may be offered as cloud services, in accordance with certain aspects.

FIG. 11 illustrates an example computer system that may be used to implement certain aspects.

### DETAILED DESCRIPTION

Techniques are described herein for processing log data items for a log index efficiently in a manner that supports scaling up or down while reducing contention for storage resources. A log processing system may use multiple queues for processing and storing information from the log data items for the same log index to multiple different storage systems. Additional queue(s) and corresponding processing instance(s) may be activated when the log processing system detects that log data is coming in faster than log data is being processed, such as when a backlog of unprocessed log data forms, persists, or grows. The processing instance(s) corresponding to the additional queue(s) use storage systems that are shared with processing instance(s) supporting the same queue but not with processing instance(s) supporting other queues. Information may be stored in a database to indicate that multiple storage systems, rather than a single storage system, store data for the log index. In various embodiments, the log processing system is implemented using non-transitory and/or transitory computer-readable storage media to store instructions which, when executed by one or more processors of a computer system, cause ingestion and indexing of log messages for accessibility by a log analysis system to support search or further analysis. The log analysis system may be implemented using non-transitory and/or transitory computer-readable storage media to store instructions which, when executed by one or more processors of a computer system, cause display of a user interface and processing of received input to display log messages or visualizations of log data, where the log messages are retrieved from multiple different storage systems for the same log index. The log processing system may be implemented on a cloud-based computer system with access to different storage systems and processing instances that may be activated and deactivated for scaling purposes, and the log analysis system may be implemented on a client system, local system, and/or cloud-based system with direct or indirect access to the different storage systems.

A description of processing log data items for a log index using multiple queues for processing and storing information from the log data items to multiple different storage systems is provided in the following sections:
LOG PROCESSING PIPELINE
SEARCH AND ANALYSIS OF INDEXED LOG DATA
SCALING LOG PROCESSING INSTANCE(S) AND DISTRIBUTING LOAD FOR A SINGLE LOG PROCESSING QUEUE
MONITORING LOG DATA LOAD TO SCALE UP OR DOWN QUEUE(S) THAT SUPPORT A LOG INDEX
BALANCING LOG DATA LOAD AMONG LOG PROCESSING INSTANCES USING SEPARATE STORAGE
SEPARATING STORAGE AND/OR PROCESSING OF OLDER LOG DATA LOAD FROM NEWER LOG DATA LOAD
ARCHIVING, PURGING, AND MERGING LOG DATA
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Log Processing Pipeline

Log data may be gathered or reported from various sources. For example, software systems, embedded systems, hardware systems, remote systems, local systems, sensors, agents, and other sources may report log data that describes operation of computing technologies throughout an interconnected computing system. The log data may be processed and analyzed to determine a health of various components of the interconnected computing system, and/or may be used to detect anomalies or troubleshoot issues. As components frequently operate according to expectations in many robust computing systems, most log data do not describe a critical issue that is subject to later analysis. That said, when a critical issue arises, without log data there is often no hope of troubleshooting, analyzing, and resolving the critical issue. Large amounts of log data are collected and processed, with a small subset of the log data ending up being highly relevant to later analysis. For that reason, effective use of log data is not possible at scale without a high level of processing, storage, and retrieval efficiency.

Log processing causes log messages to be parsed or broken apart based on matching skeletons or patterns so that individual field(s) and value(s) within log message(s) corresponding to the matching skeletons or patterns may be stored in the system, indexed to a location in the log message where the field and/or value occurs or was detected. For example, different log message patterns may be associated with different log message parsers for detecting values within the log messages. The log message may have a time that the log message was received but may have internal data such as time the log message was generated and/or other fields and values. Log messages may be streamed in (e.g., via a running agent that collects log data, for example, in increments (e.g., 30 seconds or 1MB, whichever occurs first)) and/or get loaded in bundles, such as zip files. The log processor may assign and process the data as soon as possible to mirror real time without causing a costly separate network transmission for every log message.

The agent sends the data to an ingestion service, where data is further bundled and placed in a larger zip file, such as a file that includes hundreds or even thousands of log entries. A streaming service sends a Kafka message when the bundle is saved in object storage, and a log processor subscribes to or listens to the Kafka message. The message indicates a log bundle was saved at a particular time and includes a pointer in a location in object storage where the log bundle was saved.

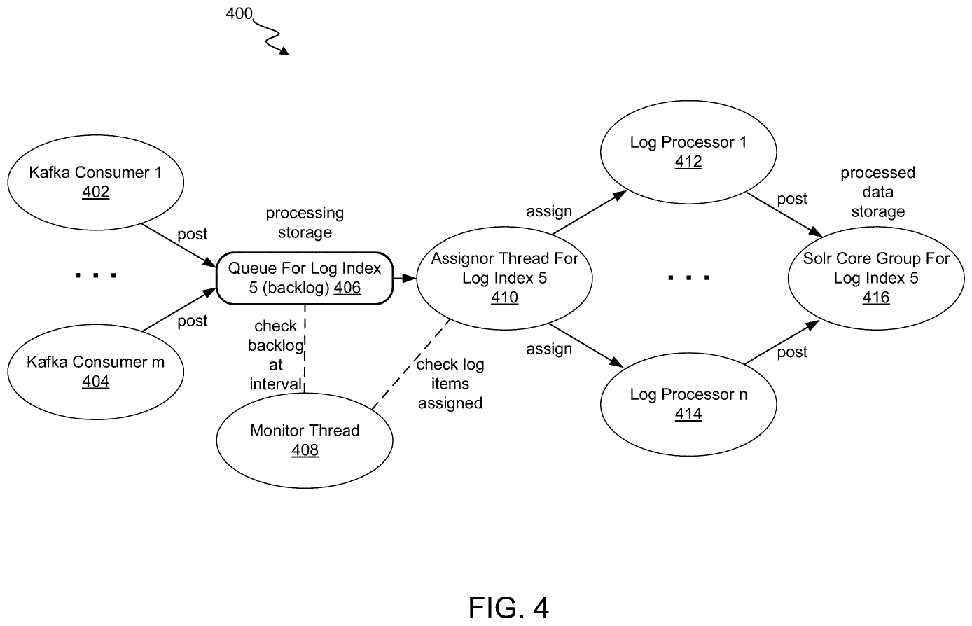

FIG. 4 illustrates a diagram of an example system 400 that processes information from log data items to a storage system associated with a log index. As shown, Kafka consumers 402 and 404 post messages to a queue for log index 5 (backlog) 406, as processing storage corresponding to the log index. A monitor thread 408 checks the backlog 406 at an interval and checks log items assigned by assignor thread for log index 5 410 to determine whether assignor thread 410 is caught up or behind in log processing. Assignor thread 410 assigns log data item work to log processors 412 and 414 from queue 406, and log processors 412 and 414 post results of the log processing to Solr Core Group for log index 5 416.

Once the Kafka consumer or other log data intake process posts a bundle to a queue, a process managing the queue may acknowledge receipt of the bundle, for example, in a network communication to the Kafka consumer. Similarly, the Kafka consumer may acknowledge, to an upstream agent or process, when messages have been received by the Kafka consumer and optionally when messages have been further received by a log processor. Further acknowledgement messages may be sent, optionally, as log messages enter different stages of processing or indexing in permanent storage.

The log processor uses the pointer to download and open the bundle from the location and determines which parsers to use for log messages in the bundle, to break the log messages down into field-specific values. The field values may be stored and indexed in Solr storage with or without a reference to the object store where the bundle is stored. Solr supports search for the stored and indexed values and may trigger notifications or other events based on the values present in the log messages. A Solr Core Group is a group of cores designated to support a particular process or functionality.

Events triggered by log processing and/or by storage in a Solr storage region may include further lookup operations or analysis of the values to determine whether notification or alert conditions are satisfied. For example, an IP address may be looked up by the log processor to see if the IP address is associated with a security issue, and an alert may be triggered to indicate the IP address is associated with a security issue. As another example, a physical location may be looked up for the IP address, and the physical location may be stored as part of the indexed values for the log record.

The log processor may have more responsibilities or less responsibilities in different systems as part of different log ingestion systems, and such responsibilities may be performed by one or multiple log processors in one or more tiers of log processors. For example, the log may be indexed on tier 1 with fields and values indexed but not on tier 2 where fields and values are categorized, tier 3 where values are looked up using external services, tier 4 where exceptions or anomalies are detected, and/or tier 5 where an LLM is used to summarize contents of the log. In one example, a tier 5 index value may be generated on-demand when data is queried and, for example, a summary is requested, and results of such on-demand evaluation may be generated and stored in-line with the request as part of the indexed log data to support search and querying of the data on a going forward basis.

In one approach, incoming log data is partitioned into different Kafka partitions, and log data for each Kafka partition is received by a Kafka consumer for the Kafka partition. The Kafka consumers receive Kafka messages, such as a bundle of contents including potentially many logs bundled together sent by a tenant or another source, as bundled by the source or an upstream service. In an example implementation, hundreds of TB of log data per day are received, processed, and indexed for a tenant of a multi-tenant log processing system, with sub-tenant data separately indexed. For example, data for different customers, partners, or organizations supported by or associated with the tenant may be stored in separate partitions corresponding to these separate sub-tenants, or multiple smaller customers associated with the tenant may be grouped together into a single sub-tenancy. A log processing system customer or tenant may choose to split up the tenant's log processing data sources into any number of sub-tenant partitions for a number of reasons, including data security, efficiency, quality of service guarantees, analytic needs, or other reasons, and a separate log index may be maintained for each of the sub-tenant partitions to promote efficient processing where surges and varying log data loads of one sub-tenant do not negatively impact another sub-tenant.

One example of a tenant may be an application platform that is a customer of the log processing system and logs data for corresponding applications. The sub-tenancy for the application platform may be broken down further based on decisions regarding which of the log customer's tenants (customers of the log processing system's customer, in the example) should be grouped together in a single sub-tenancy of logs. In a particular example, the sub-tenancy may be selected by assigning different pods to different sub-tenants. A pod is an independent process or set of processes managed by a tenant, and multiple pods may be defined to support a single tenant. A set of pods, such as hundreds or thousands of pods, may be assigned to a log index sub-tenancy for log processing.

Regardless of the characteristic(s) used by a given customer to split log data into sub-tenancies, some characteristic(s) (e.g., source characteristics, identity of a customer of the tenant relevant to the data, identity of an application or user for which the data was generated, identity of a pod or group of pods associated with the data, a type of sensor or system from which the data was reported, etc.) are used to determine which sub-tenant the data belongs, and the log data is reported for log processing in association with the sub-tenant. In other words, the characteristic(s) map the log data to a sub-tenant data set for log indexing. For example, the data may be indexed to a log index that is specific to the sub-tenant, and the log index may include one or more storage systems that are designated to store data for the log index.

The log data load may fluctuate per customer, per sub-tenant, and per-tenant, resulting in potentially large fluctuations in log data load on a multi-tenant log processing system as a whole and individual fluctuations for sub-tenant partitions that exceed log processing bandwidth, even if separate log indexes are set up to ingest data for each of the sub-tenant partitions. Customers may upload various amounts of log data to the log processing system at various times, including older data and more recent data. Decisions to bulk import older data may also burden the log processing system and result in a backlog of log data not yet processed.

In light of these variations and the high throughput of log data, at various times, any given log index can still have too much data mapped to the log index, causing a backlog of unprocessed log data items. Assigning more worker threads to the log index does not resolve the problem due to resource contention on shared storage for assigning results of the log processing. The shared storage might not be able to keep up with the throughput even though more log processing instances are assigned to process items for the log index. Also, as workload changes over time, one log index can be skewed with too much mapped data due to improper log index mapping. The log index may also experience spikes due to imbalanced uploading, or due to the instability of systems for which logs are being tracked or reported. If older data is reported with more recent data, the older data may clog the storage partitioning mechanism, making querying slow and causing undesired data archiving behaviors.

The incoming data is stored in object storage, and the notifications of individual log messages, bundles of log messages, groupings of log data, or other items of incoming log data may come to a log processing system through Kafka messages. For example, the Kafka messages may have a Kafka topic associated with multiple partitions or log indices (e.g., 3 in smaller regions and 18 in larger regions). A log processing instance or group of log processing instances corresponding to a log index may have a Kafka consumer client (Kafka consumer) that consumes messages for the log processing instance or group.

When a log processor (LP) receives a notification, the Kafka consumer registered for the log processing instance or group will store the message into a database. In this embodiment, for each log index, log messages are processed in a first-in-first-out manner in a single queue based on the Kafka message timestamp. The bundles or items of log data themselves may be stored in object storage, and the Kafka message may include a reference to a corresponding item of log data that may be retrieved from object storage. Kafka and object storage combined make up storage to support log processing and extraction of data values from log data items into processed data storage, such as a Solr Core Group, which supports querying based on the data values. Kafka and/or object storage for a log data item may be discarded after processing the log data item into the processed data storage, which may store the data indefinitely until purged, archived, or merged with other data.

A number of Kafka consumers may be bound by the number of partitions of the Kafka topic. In one example, there may be 3-18 log processing instances consuming messages from Kafka consumers at any moment. A Kafka message may already be tagged with tenant (customer) and log index information. The message may be posted to a queue of the log index.

### Search and Analysis of Indexed Log Data

As data is stored to a Solr Core Group or other indexed data storage, database records may be updated to indicate information about where data is stored and/or what aggregate summary information or value ranges are contained in larger datasets. For example, the record may indicate where a data set or database object is stored in terms of which log index and/or log index helper(s) were used to store log data for the data set, tenant and/or sub-tenant information, and/or location(s) of the Solr Core Group(s) used to store the data. The records may also indicate summary information such as which value ranges (e.g. time ranges or other value ranges) are stored in which Solr Core Group(s) such that searches against the database object may be routed to the appropriate Solr Core Group(s) that are determined to be candidate locations for storing relevant data based on the summary information, such that most database queries do not need to be evaluated against every Solr Core Group separately. The summary information may be stored in the database in association with individual datasets and/or in association with individual Solr Core Group(s).

When a query is received by the database for evaluation against a dataset that includes information stored and indexed in Solr, the database determines which Solr Core Group(s) may store information that satisfies value range(s) specified in the query such as time ranges relevant to the query for the tenant or sub-tenant whose data is involved in the query (e.g., the tenant or sub-tenant corresponding to the authenticated user for whom or by whom the query is submitted). The query or relevant portion(s) of the query may be evaluated against Solr Core Group(s) relevant to those portions of the query such that the Solr Core Group(s) use value-based indexes to retrieve information extracted from or otherwise determined from the log records and return the information for combining with information from other Solr Core Group(s) and generation of a result, by the database, in response to the query.

In various embodiments, the log processor(s) store data in a Solr Core Group indexed by value(s) detected in the log files. For example, log processors may store data partitioned by time such that data received 10 minutes ago is stored in a different partition than data received 1 minute ago. These partitions may be sized according to time interval cutoffs and/or storage space or storage contents cutoffs. For example, a new partition may be formed, corresponding to a new time range, once an old partition consumes a threshold amount of space. In another embodiment, a new partition may be formed when up to a threshold number of log records (e.g., 400 million) are stored in a prior partition. In yet another embodiment, a new partition is formed every 30 minutes or at a regular interval. This embodiment may result in evenly sized partitions for consistent log data loads but may result in unevenly sized partitions for inconsistent log data loads.

Once a new partition is formed to store log data going forward, the Solr Core Group handling storage for the log index helper or log processor(s) may continue storing data received in the new partition, marking each partition with a start time value and/or end time value of the log messages covered by that partition. The partitions may also be marked with other summary metadata that indicates what data is stored in the partition to support efficient retrieval from the partition. Such metadata and partitioning cutoff values or intervals may be used to determine where to find data that is subject of a query.

In one embodiment, the partitions are split based on Kafka message receipt time and indexed based on log event time and/or other time(s) or value(s) associated with the log message as parsed. Summary information may be maintained for each partition to support efficient search and analysis, such that individual partitions are associated with certain indexed value ranges for data known to be stored in the corresponding partition. In one example, the summary information is stored in database records that track information about where different aspects of the data sets are stored and/or what aggregate information is contained in the data sets. A query execution engine may retrieve data from the partitions that cover an index value range of the query while efficiently bypassing partitions that do not cover an index value range of the query. For example, a query for events that occurred between 10:58 a.m. and 11:00 a.m. on a particular day may be evaluated against 1, 2, or 3 log data partitions known to store data for that time period without evaluating the query against hundreds or even thousands of other candidate log data partitions.

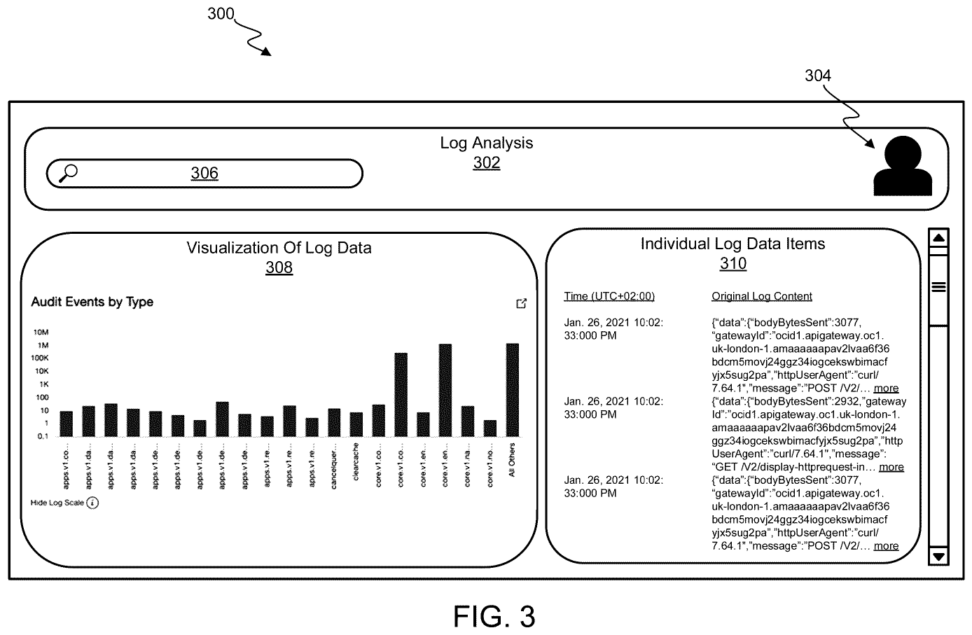

FIG. 3 illustrates a diagram of an example user interface 300 showing analysis of log data items that may include log data items retrieved from different storage systems. As shown, log analysis header 302 may include information about a user 304 logged in for log analysis and an option to search 306 or filter log messages for review. Interface 300 may include a visualization of log data 308 and/or individual log data items 310, as shown.

### Scaling Log Processing Instance(s) and Distributing Load for a Single Log Processing Queue

In one embodiment, an assignor thread monitors a queue for the log index or any queue for log data and assigns messages representing log data item(s) from the queue for processing by selected log processor instances of the log processor instances available to support log processing for that queue. The log processor instances may parse, extract, enhance, or otherwise process data from the log data items and post results of the log processing to shared permanent storage, such as a Solr Core Group for the log index or a Solr Core Group for log data processed from the respective queue. The Solr Core Group for a sub-tenant may be partitioned based on the time the log message was reported to the log processing system (e.g., the time of the message from the Kafka consumer). The data in the Solr Core Group and other Solr Core Groups may be searched using an interface such as a log analysis user interface.

As incoming data throughput grows or surges for brief periods, additional log processor instances may be instantiated to process log messages and post results to the shared permanent storage for the corresponding queue, regardless of which log index the queue supports. As a result, the shared permanent storage may become congested with many log processor instances attempting to write results of log processing to the same shared storage. If the shared permanent storage cannot handle the throughput, for example, due to CPU limits, memory limits, or transmission limits of the shared permanent storage, a backlog of unprocessed log data forms. The unprocessed log data may have been generated and received but has not fully been processed so that the log data is not available for at least some indexed pathways to support search and analysis of the log data. Excess logs streaming into a log index partition that are faster than can be handled for the log index partition causes unreliability in log data analysis with unpredictable timelines for when unprocessed log data will be partially or fully ingested or indexed into the target system. Even for a temporary surge, the backlog formed during the surge may take a considerable amount of time to clear after the surge has ended. As a result, downstream analysis and/or search may miss issues that have been logged but not yet indexed for further analysis and/or search, and the amount of unprocessed log data missing from the further analysis and/or search may be unpredictable or widely variant in different scenarios. Because log data continues to stream in over time, a log processing system that gets behind in processing for a particular sub-tenancy sometimes involves human intervention to help the indices get updated using different heavier weight mechanism(s) such as bulk-loading pre-processed data.

A log index helper is a log index but with a new dimension log index helper number, which may, for example, be stored in the database in a column such as LOG_INDEX_BACKLOG. The log index helper and the log index both process data having the same characteristics with load balancing added between the log index and log index helper(s), and the log index helper(s) use separate storage regions from the log index and from each other to efficiently avoid storage resource contention. A customer's or tenant's data is partitioned first by log index (e.g., sub-tenant), then by log index helper. This allows the log processor to scale further and avoid throughput, CPU, and/or memory bottlenecks otherwise present in scenarios that do not use log index helpers. In other words, log index helpers are assigned to the log index queue, and data is further partitioned by log index helpers that use separate storage rather than having log index helpers share storage in a Kafka core group for the log index. The log index helpers allow larger queues of unprocessed log data items for the log index to be divided into smaller manageable queues of unprocessed log data items for the log index. Also, the log index helpers allow re-use of the existing log index mechanism with minimal modification and without increased overhead (and potentially without active log index helpers) in scenarios where the main log index is able to process log data items faster than the log data items are coming into the main log index.

If log index helpers are needed during a log data load spike or backlog, additional log index helpers may be instantiated if needed or activated if already instantiated (for example, if previously initiated but in a disabled or deactivated state). The active log index helpers may have an active queue for receiving log data load. Log data items may arrive in the queue for the active log index helper by being moved out of the main queue, for example, by an assignor thread, and/or by being originally assigned to the queue for the active log index helper from the Kafka consumer or other source for log data item assignments. In a particular example, the log index helpers are inserted into a database table LP_LOG_INDEX_HELPERS, and the Kafka consumers will poll from the database table LP_LOG_INDEX_HELPERS and will start to post to the log index helpers once the log index helpers are created and activated.

In the absence of any spike or backlog, an original queue may be maintained that maps to permanent storage shared by log processing instance(s) that support the original queue, optionally without the added resources of any log index helpers and/or without the added resources of any additional Solr Core Groups specific to the log index helpers. If a spike occurs or a backlog develops, the original queue may be expanded to include additional queues that are specific to the log index and further specific to log index helpers, which may be instantiated on demand. The additional queues may each be handled by a separate log index helper that manages a separate Solr Core Group for storing results of log data processing in permanent storage that is accessible to or configured to be accessed or shared by log processing instance(s) of the separate log index helper without being accessible, configured to be accessed, or otherwise shared with the log processing instance(s) that support the original queue. Similarly, the storage system used by the log processing instance(s) that support the original queue may not be accessible to or configured to be accessed or shared by the log processing instance(s) of the separate log index helper. Similarly, storage systems used by the separate log index helpers may not be shared between log processing instances of different log index helpers, reducing storage resource contention and increasing throughput for the log processing system.

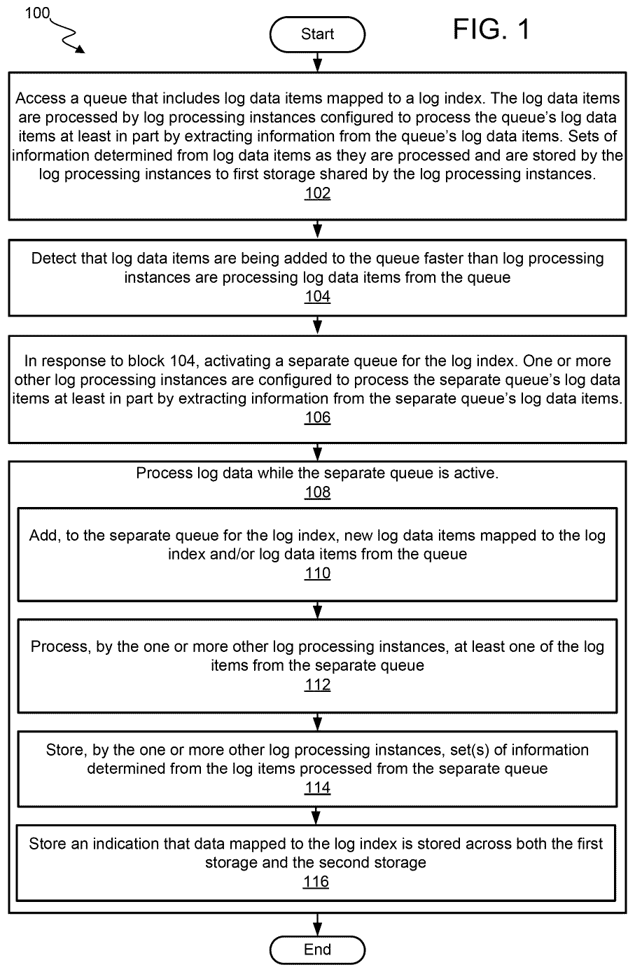

FIG. 1 illustrates a flow chart of an example process 100 that processes log data items for a log index using multiple queues for processing and stores information from the log data items to multiple different storage systems. Process 100 starts in block 102, where a log processing system accesses a queue that includes log data items mapped to a log index. The log data items are processed by log processing instances configured to process the queue's log data items at least in part by extracting information from the queue's log data items. Sets of information determined from log data items as they are processed and are stored by the log processing instances to first storage shared by the log processing instances. In block 104, the log processing system detects that log data items are being added to the queue faster than log processing instances are processing log data items from the queue. In block 106, in response to block 104, the log processing system activates a separate queue for the log index. One or more other log processing instances are configured to process the separate queue's log data items at least in part by extracting information from the separate queue's log data items. In block 108, the log processing system processes log data while the separate queue is active, including performing blocks 110, 112, 114, and 116. In block 110, the log processing system adds, to the separate queue for the log index, new log data items mapped to the log index and/or log date items from the queue. In block 112, the one or more other log processing instances of the log processing system process at least one of the log items from the separate queue. In block 114, the one or more other log processing instances store set(s) of information determined from the log items processed from the separate queue. In block 116, the log processing system stores an indication that data mapped to the log index is stored across both the first storage and the second storage.

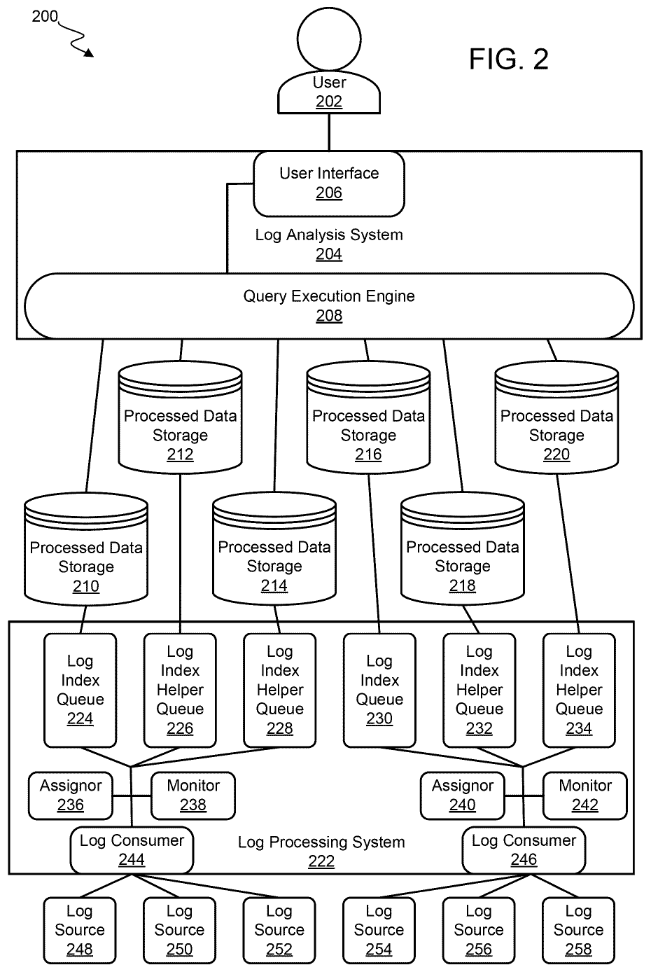

FIG. 2 illustrates a system diagram showing an example system architecture 200 configured to process log data items for a log index using multiple queues for processing and storing information from the log data items to multiple different storage systems. As shown, user 202 interacts with user interface 206 of log analysis system 204. Query execution engine receives requests on user 202's behalf and retrieves data from processed data storage 210, 212, 214, 216, 218, and/or 220 to present selection(s) of the processed data to user 202. Log processing system 222 receives messages about unprocessed log data from log sources 248, 250, 252, 254, 256, and 258. Log consumers 244 and 246 store content (“log data items”) such as messages indicating or referencing unprocessed log data in a corresponding log index queue 224 or 230, or a corresponding log index helper queue 224, 226, 232, or 234. Unprocessed log data from log index queue 224 is processed by log processor(s) for queue 224, and results are stored in processed data storage 210. Unprocessed log data from log index helper queue 226 is processed by log processor(s) for queue 226, and results are stored in processed data storage 212. Unprocessed log data from log index helper queue 228 is processed by log processor(s) for queue 228, and results are stored in processed data storage 214. Unprocessed log data from log index queue 230 is processed by log processor(s) for queue 230, and results are stored in processed data storage 216. Unprocessed log data from log index helper queue 232 is processed by log processor(s) for queue 232, and results are stored in processed data storage 218. Unprocessed log data from log index helper queue 234 is processed by log processor(s) for queue 234, and results are stored in processed data storage 220.

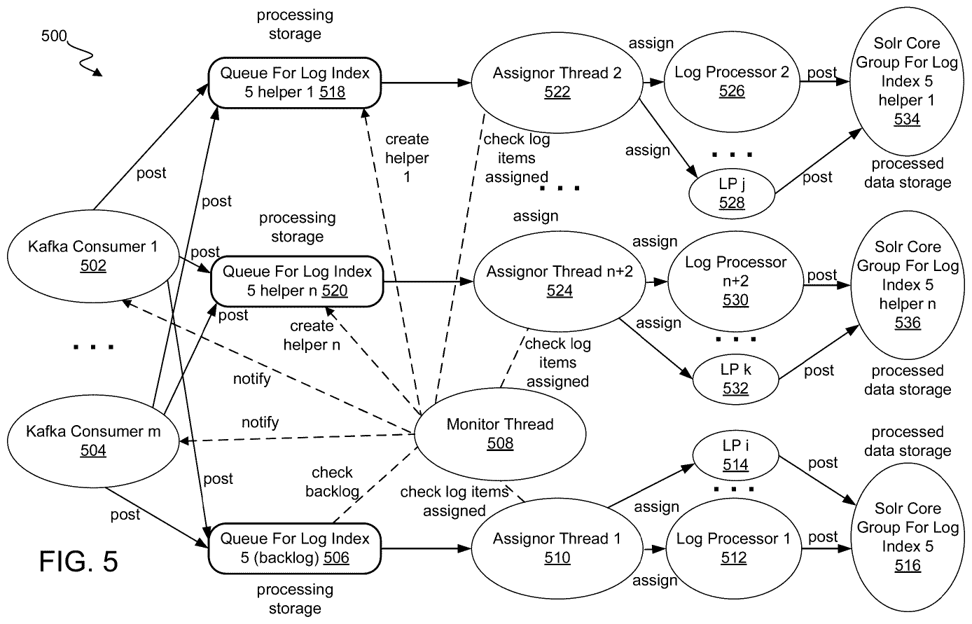

FIG. 5 illustrates a diagram of an example system 500 that processes information from log data items to different storage systems each associated with the same log index but with a different log index helper. As shown, Kafka consumers 502 and 504 post messages to a queue for log index 5 (backlog) 506, a queue for log index 5 helper 1 518, and/or a queue for log index 5 helper n 520 as processing storage corresponding to the log index. A monitor thread 508 checks the backlog 506, 518, and 520 at an interval and checks log items assigned by assignor thread 1 510 for log index 5, assignor thread 2 522 for log index 5 helper 1, and/or assignor thread n+2 524 for log index 5 helper n to determine whether assignor threads 510, 522, and/or 524 are caught up or behind in log processing. Assignor thread 510 assigns log data item work to log processors 512 and 514 from queue 506, and log processors 512 and 514 post results of the log processing to Solr Core Group for log index 5 516. Assignor thread 522 assigns log data item work to log processors 526 and 528 from queue 518, and log processors 526 and 528 post results of the log processing to Solr Core Group for log index 5 helper 1 534. Assignor thread 524 assigns log data item work to log processors 530 and 532 from queue 520, and log processors 530 and 532 post results of the log processing to Solr Core Group for log index 5 helper 1 536. FIG. 5 further shows that monitor thread 508 may initially choose to create helper 1 by creating queue 518 and/or to create helper n by creating queue 520, for example, due to backlog in queue 506.

### Monitoring Log Data Load to Scale Up or Down Queue(s) That Support a Log Index

A monitor thread may monitor the main log index thread to determine a backlog of unprocessed log data items and whether a greater or fewer number of log index helpers are needed. If a greater number of log index helpers is needed, the monitor thread may activate or initiate new log index helper(s) to handle incoming log data load. If fewer log index helpers are needed, the monitor thread may deactivate existing log index helper(s) such that the log index helpers are no longer available to be assigned additional log data load. The log index helpers may be activated to support a separate queue of log messages for the log index in addition or as an alternative to scaling log processing instances up per queue to provide additional flexibility in scalability on a per queue basis and for the log index as a whole when scaling up to support more log data load and mitigate backlog. Similarly, the log index helpers may be deactivated to stop supporting new log messages for the log index in addition or as an alternative to scaling log processing instances down per queue to provide the additional flexibility on a per queue basis and for the log index as a whole when scaling down to support less log data load and save on resource usage.

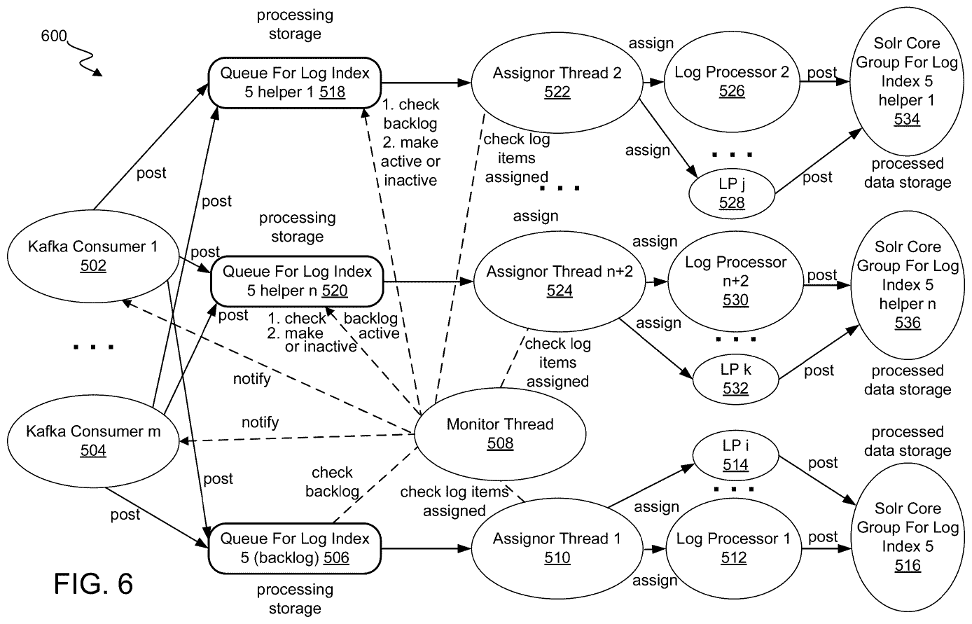

FIG. 6 shows an example system 600 where monitor thread 508 may determine to make helper thread(s) 518 and/or 520 active or inactive based after checking the backlog of queue 506. For example, thread(s) 518 and/or 520 may be deactivated upon determining that the backlog of queue 506 has cleared or activated upon determining that the backlog of queue 506 is persistent, increasing, or not clearing within backlog clearance timing constraints.

A monitor thread may monitor log data load and a rate of processing log data for one or more log indices. The monitor thread may determine the backlog from the queue for the corresponding log index, for example, from the database. The assignor and monitor may coordinate to determine how much data has been processed from the queue, for example, based on a communication from the assignor to the monitor. The monitor may take snapshots of the backlog at intervals, for example, every 10 minutes, to determine how many bundles have been processed and how much data is coming into the log processing pipeline. For example, a number of new incoming bundles may be determined by adding a backlog at time t2 (representing bundles not yet handled) to a number of bundles assigned between t1 and t2 (representing bundles being handled), and subtracting a backlog at time t1 (representing bundles that were not yet handled even at the prior time). If the existing log processing infrastructure is sufficient to support incoming load, a determination may be made as to whether scaling down is needed. Otherwise, no scaling up action is needed. If the existing log processing infrastructure is insufficient to support incoming load without a backlog, a determination may be made as to how many log index helpers to instantiate to support the log processing infrastructure.

In one embodiment, once a load surge is detected, a monitor thread calculates how many log index helpers are needed. In some embodiments, the monitor thread may wait for a threshold amount of time (e.g., 10, 15, 20, 30, 45, or 60 minutes) to determine that the load surge is not handled by the system as configured. In other embodiments, the monitor thread may determine that the surge will not be efficiently handled by the system as configured without waiting a threshold amount of time, based on aggregate throughputs in the system and a size of the load surge. In one example, the monitor thread may determine the number of log index helpers needed based on a number of new incoming bundles, messages, or other log data load and a rate of processing log data load for the log index. The number of log index helpers may be selected such that the log index helpers can accommodate the surge within a specified or desired timeline or frequency. For example, a surge of 100,000 messages may cause creation of 4 log index helpers when each log helper is able to process 30,000 messages every 5 or 10 minutes, for example, to promote a scenario where the backlog from the surge is cleared within a backlog clearing window of 5 minutes or 10 minutes, for example. Instantiating only 3 log index helpers would allow clearance of 90,000 (3×30,000) messages in the clearing window, which is not enough to clear the backlog. In the example, a number of 4 log index helpers is selected as the least number of helpers needed to clear the backlog in the clearing window.

Other durations may be used, and other log processor rates of processing may be experienced in different systems. The log index rate of processing is an average or other aggregate assigning rate of log bundles, log messages, or other units of log data load during a past N processing intervals or processing durations (e.g., 6-30 intervals or 1-5 hours). Different log helper instances may have different characteristics based on different versions of software, different supporting hardware in use or to be used by the different log helper instances, and/or different ranges of data supported by the log helper instances. The rates of processing may be specific to certain hardware or software configured to support specific log helper instance(s) that have been created or are to be created and/or data characteristics of data supported by the log helper instance(s). Additional or alternative criteria may include pre-processed aggregate characteristics of the backlog, such as information about which templates, patterns, or log parsers are likely used by the backlog and average or other aggregate processing times for log messages involving those templates, patterns, or log parsers. In different systems, different levels or layers of pre-processing may have already been completed before support by the log helper instances, and different amounts of information may be available depending on which levels of processing have been completed and which levels of processing have not yet been completed. Additional or alternative criteria may include source(s) of the log data load and aggregate processing times for log messages from those source(s). Any characteristic of the backlog that may be determined based on pre-processing the backlog prior to ingestion by the log index helpers may be used to help accurately determine how many log index helpers are needed.

A number of log index helpers needed may be checked against a maximum number of log index helpers allowed (e.g., 5, 6, 7, 8, 9, 10, 11, 12, 15, 20, or another configurable number), such that the number of log index helpers is reduced, if applicable, to the maximum allowed log index helpers.

Each log index helper may use one or multiple instances of log processors to support workload of the log index helper. The log index helper may support more workload with multiple instances of log processors sharing the same permanent storage as other log processor instances for the same log index helper, which is different permanent storage than the permanent storage being used by other log processor instances handling workload for other log index helpers. Each permanent storage partition is split based on log index helper such that the log index helpers may, in one embodiment, scale up to a maximum processing throughput within each of the partitions by adding log processing instances for the partition corresponding to the log index helper until the maximum processing throughput is reached. In various embodiments, a fixed cap (e.g., 3, 4, 5, 6, 7, or 8, or any other configurable number) of log processors may be instantiated for each log index helper to avoid overburdening the storage managed for the log index helper. In other embodiments, the cap may be dynamically determined based on average or other aggregate wait times or latency for accessing the permanent storage to post results.

A separate assignor thread may be used for each log index helper and the main log index to assign log data items from the respective queues to log processing instances available to process the log data items from the respective queues. For example, the assignor thread may assign a next available log data item from the queue to a next available log processing instance corresponding to the log index helper or main log index. Each of the main log index and the log index helper(s) may have one or multiple separate log processing instances to process log data items for a corresponding queue.

A monitoring thread may efficiently monitor the incoming data rate, for example, by taking snapshots of bundles or other log data items assigned and a backlog of a log index on a periodic basis (e.g., every 10 minutes or any other interval). The monitoring thread may coordinate with the separate assignor threads to determine a total processing throughput and average processing throughput for log data items of the log index and compare the processing throughput(s) to the backlog or other incoming log data rate, optionally accounting for trending up or down of the backlog or incoming log data rate over time. Based on the processing throughput and the backlog or other indication of the incoming log data rate, the monitoring thread may determine whether to scale up to add log index helpers, increase a number of log index helpers, or add log processing instances to a log index helper or to the main log index, or to scale down to decrease a number of log index helpers, stop using log index helpers, or decrease a number of log processing instances for a log index helper or for the main log index.

As a log data load goes down and/or the backlog clears, a number of log index helpers may be reduced by disabling active log index helpers down to a number of log index helpers that are determined, based on remaining log data load, to be sufficient for processing the log data within specified time constraints. In one embodiment, if there is no backlog, a number of log index helpers is reduced to zero, and processing returns to a single log index queue. In another embodiment, a number of log index helpers may be reduced to a non-zero number if the single log index queue is not predicted to be able to keep up with the current or predicted log data load and/or if there is still a backlog to clear.

After a log index helper has been disabled, the Solr Core Group for the log index helper may remain in permanent storage to support querying of any data that fits within the indexed value ranges within the Solr Core Group. Deactivated log index helpers may therefore still have permanent storage resources consumed in the system until such storage has been merged with other permanent storage, archived, or purged, but such permanent storage resources are also available to support search or further analysis. If the log index helper is needed again due to a surge in log data load, additional resources may be added to the Solr Core Group for the log index helper, with additional value indexes being covered by the Solr Core Group managed by the log index helper. For example, a log index helper may have been active between 7:00 a.m. and 7:50 a.m. to reduce a backlog. The log index helper may be deactivated at 7:50 a.m. after the backlog is cleared and re-activated from 11:20 a.m. until 11:50 a.m. In this example, the Solr Core Group for the log index helper may cover data from 6:50 a.m. when a backlog began to 7:48 a.m. when the backlog was cleared, and from 11:00 a.m. until 11:46 a.m. as another backlog was cleared. In the example, although disabled, the Solr Core Group for the log index helper continues to store the data in allocated memory until purged, archived, or merged with another data set. When a search query or request for data is received, data spanning those time periods may be evaluated using the Solr Core Group for the log index helper as well as any other Solr Core Groups for any other log index helpers that may also cover a time period covered by the query or other data request. The time periods for the different Solr Core Groups may overlap because they are supported by different log index helpers that were active at the same time handling a backlog of log data load. Results from the different Solr Core Groups may be merged to provide a result for the query or other data request.

Solr Core Groups for log index helpers that remain active may continue to grow in size as the log index helpers handle log data load, with newly indexed information being stored in the Solr Core Groups to support search and further analysis. In various embodiments, Solr Core Groups include up to a maximum number of log records, up to a maximum amount of space that can be consumed by log records, up to a maximum time span that can be covered by log records stored in the Solr Core Group, and/or up to a maximum number of partitions. If a maximum threshold such as one of these thresholds is reached, a new Solr Core Group may be formed to continue storing data for the log index helper or log processor(s) that are processing log data and posting processed or indexed data. The posted data may be saved to the Solr Core Group that may be efficiently created as a threshold is reached or near (e.g., within a threshold percentage of) being reached.

Techniques described herein utilizing multiple queues to support a single log index could be applied to any tier of log processing or indexing, such that the log index for a first tier of processing, second tier of processing, third tier of processing, and so on, may be scaled using log index helpers to accommodate log data load spikes for further processing of the log data, whether the log data is unprocessed, partially processed, or even indexed based on some values extracted from the log data but not indexed based on some yet-to-be-performed lookup operations (optionally further based on the extracted values).

### Balancing Log Data Load Among Log Processing Instances Using Separate Storage

In one embodiment, a Kafka consumer randomly assigns log messages to a log index helper or the main log index in order to evenly distribute log messages over time. For example, the randomization may be accomplished based on a hash of values from the log messages and/or by use of a random number generator. In this scenario of randomly selecting a queue for a log data item, if the log index helpers have enough capacity, the load among them may be statistically balanced with minimal overhead. In some scenarios where some log index helpers process data slower than others for various reasons (e.g., Solr busy, high CPU usage by the log processing instance(s), etc.), log index helpers might not have enough capacity to process the data assigned to the log index helper. In this scenario, to balance load effectively, the log processing system may perform any one or more of the following mitigations: (1) limit the backlog of log index helpers to a maximum threshold (e.g., 10 k or another configurable amount), such that extra backlog if any is accumulated on the original log index, and/or (2) the assigner thread (n+1) of the original log index may monitor the backlog of any or all log index helpers and the original log index. If the backlog of the original log index is greater than or approaching a threshold (e.g., 10 k), the assignor thread may assign load from original backlog to log index helpers in small batches (up to 1 k at a time per log index helper per batch). In this example, the assignment flow is one-way from original log index to log index helpers, and there is no back-and-forth communication from one log index helper to another or from log index helpers to original log index. Such reassignment from the log index to a log index helper may be accomplished without any locking thus avoiding resource contention and promoting efficiency.

In another embodiment, a Kafka consumer or other log data intake process may check which log index helper or main log index thread has the smallest queue of bundles to be processed and may assign a next log bundle to the log index helper or main log index thread with the smallest queue of bundles. This embodiment may encounter the significant additional overhead of accessing queue size information by the Kafka consumers. Another example of spreading data across the log index helpers include an even sequential distribution, where each log index helper or the log index receives a next queue and becomes last in line for receiving data. Another example is spreading the log data with an affinity for certain data characteristics that may be gleaned from the message. Another example is spreading the log data according to a non-random algorithm that achieves balance or approaches balances across the log index helpers and the log index.

Regardless of how data is spread across the log index helpers, the log index helpers may be capped at a maximum threshold queue size (e.g., 10,000 bundles). A monitor thread may temporarily deactivate a log index helper that has reached the maximum threshold queue size and later reactivate the log index helper once the log index helper reaches a lower threshold size. If the log index helpers are all at the maximum threshold queue size, additional bundles may be added to the main log index thread.

The monitoring thread may check the backlog of all log index helpers. If the backlog of an enabled log index helper exceeds a certain threshold (for example, a default of 10 k, which may be configurable), the status of log index helper will be set to inactive so Kafka consumers will not post to its queue. This would limit the backlog of log index helpers to roughly 10 k.

Once the backlog of a log index helper is lower than another threshold (default 5 k, configurable), a status of the log index helper may be set to active so Kafka consumers can resume posting to the queue of the log index helper. The different threshold of 10 k/5 k is to avoid too frequent of a status change.

In one embodiment, when the rate of incoming data bundles or other log data items is within the capacity of all log index helpers and the original log index, the load is roughly balanced and the backlog of each log index helper is not likely to exceed the threshold (e.g., 10 k). Sometimes the incoming rate is higher than total log processing capacity for the log index plus helpers, in which case the excessive backlog may accumulate on the original log index. The assigner thread (n+1) for the original log index may monitor the backlog of the log index helpers and periodically reassigns messages (bundles) or other log data items to log index helpers whose backlog is lower than the maximum threshold (e.g., 10 k). This reassignment is done in batches at a maximum amount (e.g., 1 k, which may be configurable) per batch per log index helper. For example, this re-assignment may be done one-way, i.e. from original log index to log index helpers, to avoid use of expensive resource locking mechanisms. If only the assigner thread of the original log index handles this reassignment, the assignor thread may not be competing with another thread for access to the log data items. In this example, a message (bundle) or log data item may be reassigned at most once unless a log index helper fails, in which case workload of the log index helper may be failed over to another log index helper or revert to the main log index.

In one embodiment, an assignor thread removes log bundles or other log data items (e.g., in batches of, for example, 1 k log data items at a time) from the main log index thread and adds the log bundles or other log data items to a queue of a log index helper to reduce a backlog on the main log index thread. To avoid resource contention, the removed log bundles may be bundles beyond a current processing cycle for the main log index thread. The re-assigned log bundles may be processed by the log index helpers in their corresponding queues and saved to corresponding Solr Core Groups to avoid or reduce resource contention with the main log index thread, which uses a separate Solr Core Group.

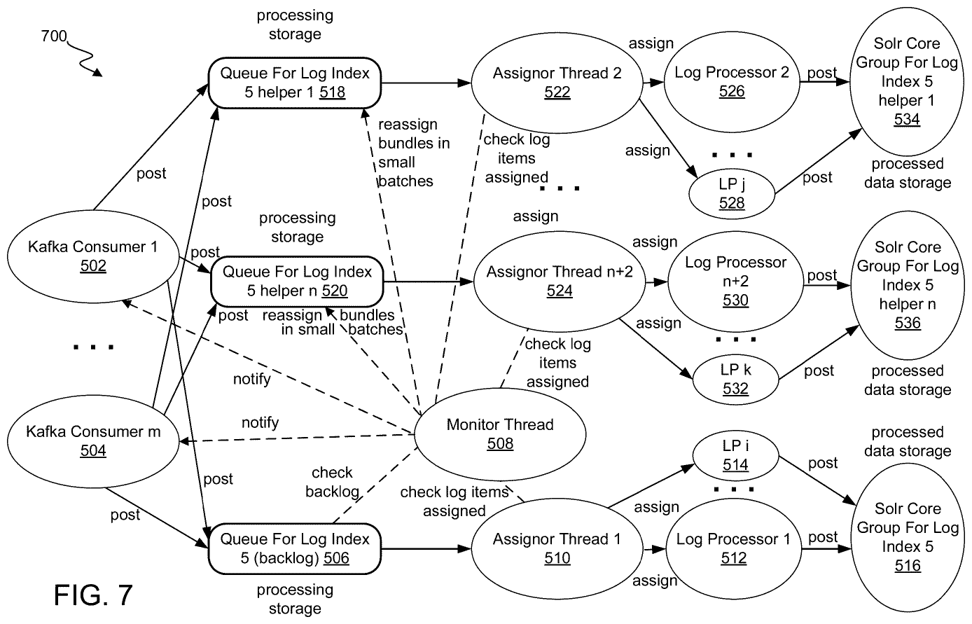

FIG. 7 shows an example system 700 where monitor thread 508 may determine to reassign bundles in small batches to helper queue(s) 518 and/or 520, for example, based on determining that a backlog in queue 506 is above a threshold and that helper queue(s) 518 and/or 520 can accommodate additional log data items (e.g., would not exceed an upper threshold queue length with the reassigned items).

If a log index helper fails, the queue assigned to the log index helper may be distributed among other log index helpers or assigned to a newly initiated log index helper for processing. The monitor thread may detect the failure and determine whether to initiate a new log index helper and/or distribute the load among other log index helper(s).

In various embodiments, absent failure, log bundles stored in a queue for a log index helper are not passed between log index helpers. In this manner, the queue does not need to be locked in order to store the log bundle to the queue and to have a single log index helper access the queue for removing the log bundle from the queue when processed. Avoiding locks on the log index helper queues may further improve efficiency of the log processing system.

Separating Storage and/or Processing of Older Log Data Load From Newer Log Data Load

In some scenarios, very old data being uploaded may delay processing of more recent data being uploaded at the same time, causing further unreliability and unpredictability. Occasionally, due to uptime and downtime of upstream systems, targeted analyses being performed with respect to upstream systems, and/or ongoing data synchronization projects, data detailing older log events (e.g., events older than a threshold absolute or relative time) may be pushed into the system along with the data detailing more recent log events. The “older” data may have been reported, through a Kafka consumer, more or less recently than the “more recent” data, but log events covered by the “older” data occurred before log events covered by the “more recent” data (and before the absolute or relative threshold time). In order to avoid having older data delay log intake for more recent data, older data coming in as part of the log data load may be stored by each log index helper in a Solr Core Group designated for the log index helper to store older data while more recent data is stored in a Solr Core Group designated for the log index helper to store the more recent data. In another embodiment, each of the log index helpers and the main log processing thread may have a separate Solr Core Group for recent data and for older data. The Solr Core Group for the older data may be cut off based on a certain time threshold, such as log data over 30 days old, and new Solr Core Groups may be created periodically to handle log data over a more recent period of, for example, 30 days.

In another embodiment, if pre-processing includes determining a log event time, older data received may be assigned to one or more log index helper(s) designated to handle the older data, and/or re-assigned from the main log processing thread to the one or more log index helper(s) designated to handle the older data.

For various reasons, very old data (month(s), quarter(s), or year(s) prior to the processing time) may be input into the log processing system. Although old data may be recently received, the old data may cover log events that occurred beyond a threshold amount of time in the past. Mixing old and new data is inefficient for querying and archiving data, as non-contiguous data is not often queried together and may result in degraded performance if stored in the same partition. Since the volume of old data can be at times very high, the log processing system may process the old data at large scale as well while mitigating the costs. In one embodiment, each log index helper and/or the main log index may further partition the data into old and new using a configurable duration (e.g., a default of 1 year prior to the processing date). Using the separate partitions results in having the customer's data partitioned by log index, log index helper, and duration. The existing log index mechanism may be enhanced to handle old data by adding a partition for each log index helper and the main log index. Each log index helper, a given or designated log index helper, and/or the main log index may have an old log index helper available for processing old log data load in a respective queue. The old log index helper would handle the old log data load using a separate Solr Core Group or separate storage, to avoid resource contention and shared partitioning with the more recent log data. Data older than the threshold may be re-directed to the old log index helper, for example, by an assignor thread or by the log processing instance that extracts data indicating that the processed log data item is an old item.

Accordingly, more recent data may be stored in a main storage for the log index or log index helper, and data older than the threshold may be stored in a secondary storage for the log index or log index helper. The secondary storage would be designated for storing older log data items and may be configured with different rules than the main storage for archiving, purging, and/or merging data over time.

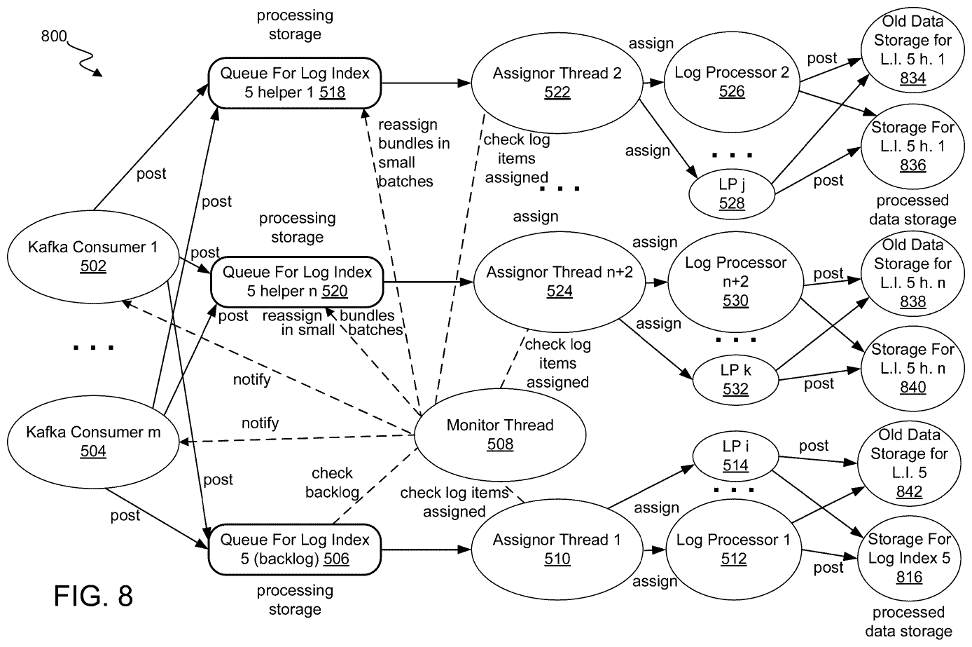

FIG. 8 illustrates a diagram of an example system 800 that processes information from log data items to different storage systems for old data and for recent data, as well as different storage systems for log index helpers and for the main log index. As shown, Kafka consumers 502 and 504 post messages to a queue for log index 5 (backlog) 506, a queue for log index 5 helper 1 518, and/or a queue for log index 5 helper n 520 as processing storage corresponding to the log index. A monitor thread 508 checks the backlog 506, 518, and 520 at an interval and checks log items assigned by assignor thread 1 510 for log index 5, assignor thread 2 522 for log index 5 helper 1, and/or assignor thread n+2 524 for log index 5 helper n to determine whether assignor threads 510, 522, and/or 524 are caught up or behind in log processing. Assignor thread 510 assigns log data item work to log processors 512 and 514 from queue 506, and log processors 512 and 514 post results of the log processing for older log data items to old data storage for log index 5 842. For more recent items, log processors 512 and 514 post results to storage for log index 5 816. Assignor thread 522 assigns log data item work to log processors 526 and 528 from queue 518, and log processors 526 and 528 post results of the log processing to old data storage for log index 5 helper 1 836. For more recent items, log processors 526 and 528 post results to storage for log index 5 helper 1 836. Assignor thread 524 assigns log data item work to log processors 530 and 532 from queue 520, and log processors 530 and 532 post results of the log processing to old data storage for log index 5 helper n 838. For more recent items, log processors 530 and 532 post results to storage for log index 5 helper n 840.

### Archiving, Purging, and Merging Log Data

As time goes on after processing a log, in various scenarios, a likelihood that the log data will be used for further analysis may decrease. Depending on settings of the log management system, log data may be archived after a threshold amount of time (e.g., 2 days, 7 days, 10 days, 15 days, or 30 days) has passed, and/or purged after a threshold amount of time has passed. In a system that performs both archiving and purging, an archiving may occur after a first threshold amount of time has passed, and a purging may occur after a second, greater threshold amount of time has passed. Archiving and/or purging the data allows optimal usage of the Solr Core Group for managing recent or most relevant log data, while relying on object storage or a data warehouse to store less recent or less relevant log data. Archiving and purging promote efficient use of resources, which may lead to a less expensive implementation. Data may be recalled from archived storage for use by the log management system in case such data is the subject of a later query. Such data may be identified as the subject of a later query, for example, based on query parameters that include a time or other characteristics covered by the dataset stored in object storage, for example, as determined from metadata stored about the data in object storage.

In one embodiment, purging the data includes purging log processing data that was generated after the purge period without purging underlying object storage data from which the log processing data is based. High-level metadata based on the log processing data, such as data ranges, time periods, or other aggregate information for a set of many log records, may be maintained for batches of the log processing data without maintaining log data on a log-by-log basis. Value ranges and other value tags for the set of data may be maintained in the high-level metadata on a batch-by-batch basis or for clusters of batches or other groups of log data based on values for different fields that are detected within the log records during an initial processing of the log records, before the detailed log processing data has been purged. If the lower-level data is needed after the purge period, such lower-level log data may be regenerated by re-processing only that log data that satisfies high-level metadata corresponding to the query. For example, the log management system may re-parse a batch of logs to support analysis after an initial parsing of the batch has already been purged but metadata for the batch indicates that the batch includes at least one log record that is within a data value range of the query.

In various embodiments, purging and/or archiving the data causes space previously allocated to store the data to be freed up for storing new log data. In a cloud environment, the unused storage space may be returned to a pool from which the log processing system or other systems may use without charging a customer of the log processing system for unused storage space. In this manner, the customer may save in cost of storage resources due to lower resource utilization. Data archived to another system, such as a data warehouse or another back-end database, may also include charges for storage resources, but, as such data may no longer be indexed and loaded to support active search or analysis functionality of a log processing system, such costs may be considerably lower than the costs of storing resources indexed and loaded to support the active search or analysis functionality. Evaluating queries on archived or purged data may involve additional indexing and/or pre-processing before the query can be fully executed. In some embodiments, purged data might not be available for recovery even through pre-processing if unindexed and unparsed source log files have also been purged.

In some embodiments, data is purged and/or archived based on whether overall cloud storage limits have been reached. The data to be purged or archived may be set as the oldest data that has not been marked for keeping. For example, some of the older data may be marked for keeping to avoid purging or archiving business-critical data. The oldest data not marked may be purged or archived to make room for more recent data to be processed, indexed, and stored by the log processing system. More recent data may be prioritized in many systems to support querying and further analysis of data that has a greater impact on current system operations rather than prioritizing historical data. In other systems, data may be prioritized according to a critical date that is not the current date but is a date of targeted analysis in the past. In this example, data furthest from the critical date may be purged or archived regardless of recency. In other examples, data within a threshold time range of a critical date or event may be marked for keeping to avoid purging or archiving data potentially relevant to the critical data or event, such as a system exception, failure, intrusion, or other anomaly or event.

### Computer System Architecture

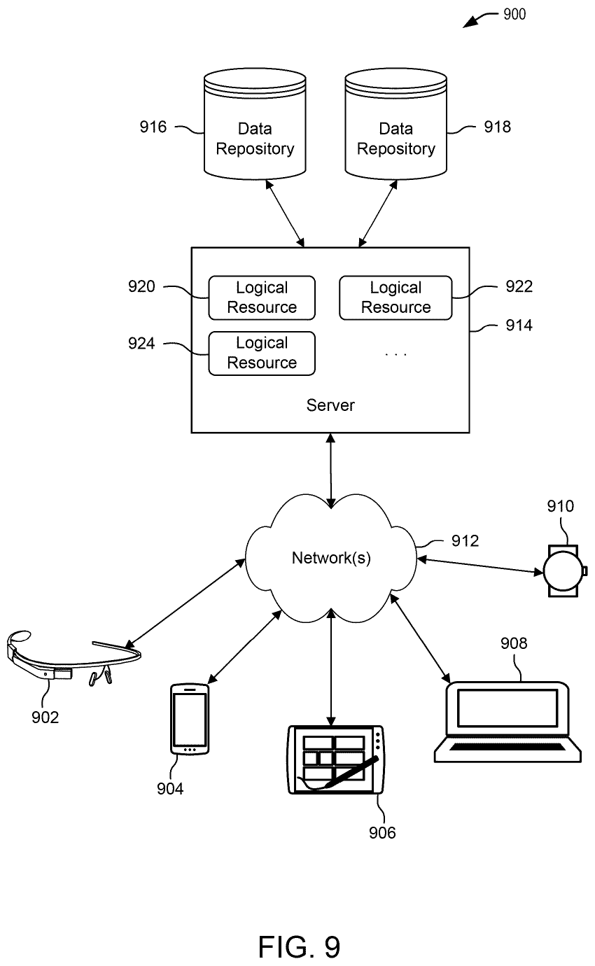

FIG. 9 depicts a simplified diagram of a distributed system 900 for implementing an embodiment. In the illustrated embodiment, distributed system 900 includes one or more client computing devices 902, 904, 906, 908, and/or 910 coupled to a server 914 via one or more communication networks 912. Clients computing devices 902, 904, 906, 908, and/or 910 may be configured to execute one or more applications.

In various aspects, server 914 may be adapted to run one or more services or software applications that enable techniques for processing log data items for a log index using multiple queues for processing and storing information from the log data items to multiple different storage systems.

In certain aspects, server 914 may also provide other services or software applications that can include non-virtual and virtual environments. In some aspects, these services may be offered as web-based or cloud services, such as under a Software as a Service (Saas) model to the users of client computing devices 902, 904, 906, 908, and/or 910. Users operating client computing devices 902, 904, 906, 908, and/or 910 may in turn utilize one or more client applications to interact with server 914 to utilize the services provided by these components.

In the configuration depicted in FIG. 9, server 914 may include one or more components 920, 922 and 924 that implement the functions performed by server 914. These components may include software components that may be executed by one or more processors, hardware components, or combinations thereof. It should be appreciated that various different system configurations are possible, which may be different from distributed system 900. The embodiment shown in FIG. 9 is thus one example of a distributed system for implementing an embodiment system and is not intended to be limiting.

Users may use client computing devices 902, 904, 906, 908, and/or 910 for techniques for processing log data items for a log index using multiple queues for processing and storing information from the log data items to multiple different storage systems. in accordance with the teachings of this disclosure. A client device may provide an interface that enables a user of the client device to interact with the client device. The client device may also output information to the user via this interface. Although FIG. 9 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 912 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 912 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 914 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 914 can include one or more virtual machines running virtual operating systems, or other computing architectures involving virtualization such as one or more flexible pools of logical storage devices that can be virtualized to maintain virtual storage devices for the server. In various aspects, server 914 may be adapted to run one or more services or software applications that provide the functionality described in the foregoing disclosure.

The computing systems in server 914 may run one or more operating systems including any of those discussed above, as well as any commercially available server operating system. Server 914 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM ® (International Business Machines), and the like.

In some implementations, server 914 may include one or more applications to analyze and consolidate data feeds and/or event updates received from users of client computing devices 902, 904, 906, 908, and/or 910. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 914 may also include one or more applications to display the data feeds and/or real-time events via one or more display devices of client computing devices 902, 904, 906, 908, and/or 910.

Distributed system 900 may also include one or more data repositories 916, 918. These data repositories may be used to store data and other information in certain aspects. For example, one or more of the data repositories 916, 918 may be used to store information for techniques for processing log data items for a log index using multiple queues for processing and storing information from the log data items to multiple different storage systems. Data repositories 916, 918 may reside in a variety of locations. For example, a data repository used by server 914 may be local to server 914 or may be remote from server 914 and in communication with server 914 via a network-based or dedicated connection. Data repositories 916, 918 may be of different types. In certain aspects, a data repository used by server 914 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 916, 918 may also be used by applications to store application data. The data repositories used by applications may be of different types such as, for example, a key-value store repository, an object store repository, or a general storage repository supported by a file system.

In one embodiment, server 914 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

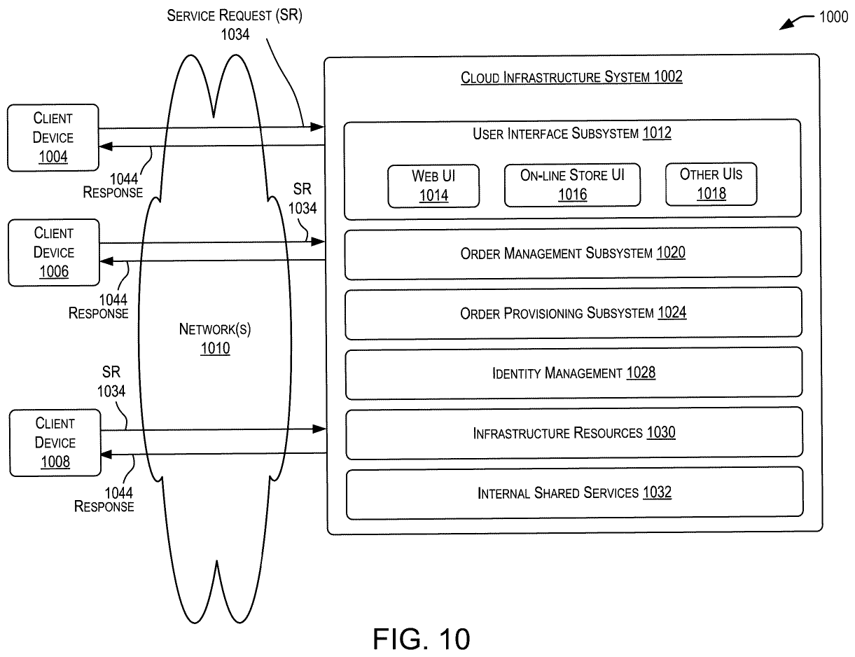

FIG. 10 is a simplified block diagram of a cloud-based system environment in which log data items for a log index are processed using multiple queues for processing and information is stored from the log data items to multiple different storage systems, in accordance with certain aspects. In the embodiment depicted in FIG. 10, cloud infrastructure system 1002 may provide one or more cloud services that may be requested by users using one or more client computing devices 1004, 1006, and 1008. Cloud infrastructure system 1002 may comprise one or more computers and/or servers that may include those described above for server 914. The computers in cloud infrastructure system 1002 may be organized as general purpose computers, specialized server computers, server farms, server clusters, or any other appropriate arrangement and/or combination.

Network(s) 1010 may facilitate communication and exchange of data between clients 1004, 1006, and 1008 and cloud infrastructure system 1002. Network(s) 1010 may include one or more networks. The networks may be of the same or different types. Network(s) 1010 may support one or more communication protocols, including wired and/or wireless protocols, for facilitating the communications.

The embodiment depicted in FIG. 10 is only one example of a cloud infrastructure system and is not intended to be limiting. It should be appreciated that, in some other aspects, cloud infrastructure system 1002 may have more or fewer components than those depicted in FIG. 10, may combine two or more components, or may have a different configuration or arrangement of components. For example, although FIG. 10 depicts three client computing devices, any number of client computing devices may be supported in alternative aspects.

The term cloud service is generally used to refer to a service that is made available to users on demand and via a communication network such as the Internet by systems (e.g., cloud infrastructure system 1002) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1010 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1002 may provide one or more cloud services using different models such as under a Software as a Service (Saas) model, a Platform as a Service (PaaS) model, an Infrastructure as a Service (IaaS) model, a Data as a Service (DaaS) model, and others, including hybrid service models. Cloud infrastructure system 1002 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1002. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1002. Cloud infrastructure system 1002 then performs processing to provide the services requested in the tenant's subscription order. Cloud infrastructure system 1002 may be configured to provide one or even multiple cloud services.

Cloud infrastructure system 1002 may provide the cloud services via different deployment models. In a public cloud model, cloud infrastructure system 1002 may be owned by a third party cloud services provider and the cloud services are offered to any general public tenant, where the tenant can be an individual or an enterprise. In certain other aspects, under a private cloud model, cloud infrastructure system 1002 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1002 and the services provided may be shared by several organizations in a related community. Various other models such as hybrids of the above mentioned models may also be used.

Client computing devices 1004, 1006, and 1008 may be of different types (such as devices 902, 904, 906, and 908 depicted in FIG. 9) and may be capable of operating one or more client applications. A user may use a client device to interact with cloud infrastructure system 1002, such as to request a service provided by cloud infrastructure system 1002.

In some aspects, the processing performed by cloud infrastructure system 1002 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1002 for determining the intent of an utterance. The data used for this analysis may include structured data (e.g., data stored in a database or structured according to a structured model) and/or unstructured data (e.g., data blobs (binary large objects)).

As depicted in the embodiment in FIG. 10, cloud infrastructure system 1002 may include infrastructure resources 1030 that are utilized for facilitating the provision of various cloud services offered by cloud infrastructure system 1002. Infrastructure resources 1030 may include, for example, processing resources, storage or memory resources, networking resources, and the like.

In certain aspects, to facilitate efficient provisioning of these resources for supporting the various cloud services provided by cloud infrastructure system 1002 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1002 may itself internally use services 1032 that are shared by different components of cloud infrastructure system 1002 and which facilitate the provisioning of services by cloud infrastructure system 1002. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1002 may comprise multiple subsystems. These subsystems may be implemented in software, or hardware, or combinations thereof. As depicted in FIG. 10, the subsystems may include a user interface subsystem 1012 that enables users of cloud infrastructure system 1002 to interact with cloud infrastructure system 1002. User interface subsystem 1012 may include various different interfaces such as a web interface 1014, an online store interface 1016 where cloud services provided by cloud infrastructure system 1002 are advertised and are purchasable by a consumer, and other interfaces 1018. For example, a tenant may, using a client device, request (service request 1034) one or more services provided by cloud infrastructure system 1002 using one or more of interfaces 1014, 1016, and 1018. For example, a tenant may access the online store, browse cloud services offered by cloud infrastructure system 1002, and place a subscription order for one or more services offered by cloud infrastructure system 1002 that the tenant wishes to subscribe to. The service request may include information identifying the tenant and one or more services that the tenant desires to subscribe to. For example, a tenant may place a subscription order for a chatbot related service offered by cloud infrastructure system 1002. As part of the order, the client may provide information identifying the input (e.g. utterances).

In certain aspects, such as the embodiment depicted in FIG. 10, cloud infrastructure system 1002 may comprise a service management subsystem (OMS) 1020 that is configured to process the new order. As part of this processing, OMS 1020 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1020 may then invoke the service provisioning subsystem (OPS) 1024 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1024 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1002 may send a response or notification 1044 to the requesting tenant to indicate when the requested service is now ready for use. In some instances, information (e.g., a link) may be sent to the tenant that enables the tenant to start using and availing the benefits of the requested services.

Cloud infrastructure system 1002 may provide services to multiple tenants. For each tenant, cloud infrastructure system 1002 is responsible for managing information related to one or more subscription orders received from the tenant, maintaining tenant data related to the orders, and providing the requested services to the tenant or clients of the tenant. Cloud infrastructure system 1002 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1002 may provide services to multiple tenants in parallel. Cloud infrastructure system 1002 may store information for these tenants, including possibly proprietary information. In certain aspects, cloud infrastructure system 1002 comprises an identity management subsystem (IMS) 1028 that is configured to manage tenant's information and provide the separation of the managed information such that information related to one tenant is not accessible by another tenant. IMS 1028 may be configured to provide various security-related services such as identity services, such as information access management, authentication and authorization services, services for managing tenant identities and roles and related capabilities, and the like.

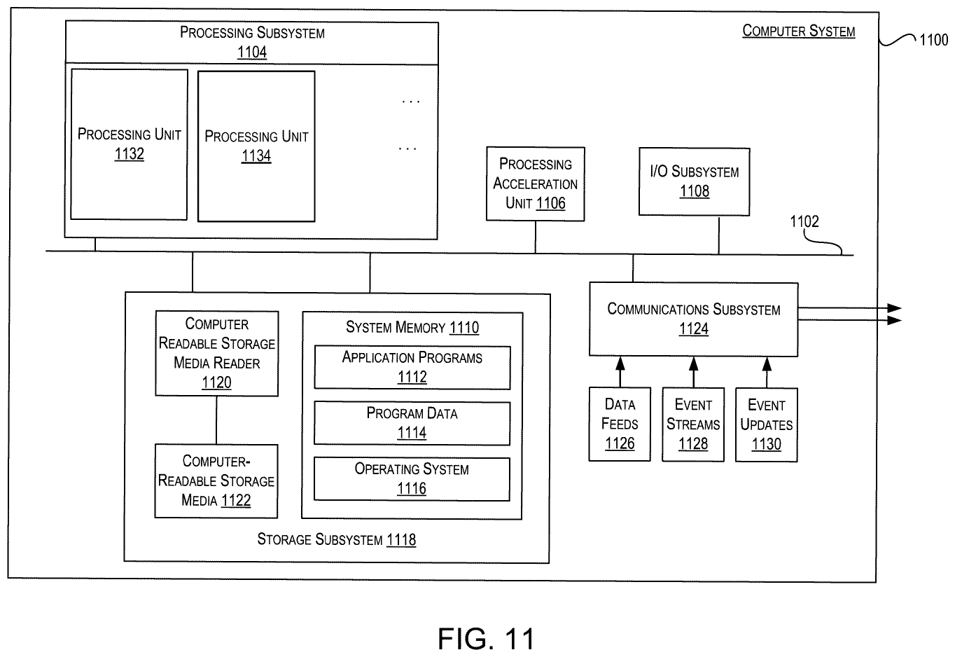

FIG. 11 illustrates an exemplary computer system 1100 that may be used to implement certain aspects. As shown in FIG. 11, computer system 1100 includes various subsystems including a processing subsystem 1104 that communicates with a number of other subsystems via a bus subsystem 1102. These other subsystems may include a processing acceleration unit 1106, an I/O subsystem 1108, a storage subsystem 1118, and a communications subsystem 1124. Storage subsystem 1118 may include non-transitory and/or transitory computer-readable storage media including storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative aspects of the bus subsystem may utilize multiple buses. Bus subsystem 1102 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1104 controls the operation of computer system 1100 and may comprise one or more processors, application specific integrated circuits (ASICs), or field programmable gate arrays (FPGAs). The processors may be single core or multicore processors. The processing resources of computer system 1100 can be organized into one or more processing units 1132, 1134, etc. A processing unit may include one or more processors, one or more cores from the same or different processors, a combination of cores and processors, or other combinations of cores and processors. In some aspects, processing subsystem 1104 can include one or more special purpose co-processors such as graphics processors, digital signal processors (DSPs), or the like. In some aspects, some or all of the processing units of processing subsystem 1104 can be implemented using customized circuits, such as application specific integrated circuits (ASICs), or field programmable gate arrays (FPGAs).

In some aspects, the processing units in processing subsystem 1104 can execute instructions stored in system memory 1110 or on computer readable storage media 1122. In various aspects, the processing units can execute a variety of programs or code instructions and can maintain multiple concurrently executing programs or processes. At any given time, some or all of the program code to be executed can be resident in system memory 1110 and/or on computer-readable storage media 1122 including potentially on one or more storage devices. Through suitable programming, processing subsystem 1104 can provide various functionalities described above. In instances where computer system 1100 is executing one or more virtual machines, one or more processing units may be allocated to each virtual machine.

In certain aspects, a processing acceleration unit 1106 may optionally be provided for performing customized processing or for off-loading some of the processing performed by processing subsystem 1104 so as to accelerate the overall processing performed by computer system 1100.

I/O subsystem 1108 may include devices and mechanisms for inputting information to computer system 1100 and/or for outputting information from or via computer system 1100. In general, use of the term input device is intended to include all possible types of devices and mechanisms for inputting information to computer system 1100. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1100 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1118 provides a repository or data store for storing information and data that is used by computer system 1100. Storage subsystem 1118 provides a tangible non-transitory computer-readable storage medium for storing the basic programming and data constructs that provide the functionality of some aspects. Storage subsystem 1118 may store software (e.g., programs, code modules, instructions) that when executed by processing subsystem 1104 provides the functionality described above. The software may be executed by one or more processing units of processing subsystem 1104. Storage subsystem 1118 may also provide a repository for storing data used in accordance with the teachings of this disclosure.

Storage subsystem 1118 may include one or more non-transitory memory devices, including volatile and non-volatile memory devices. As shown in FIG. 11, storage subsystem 1118 includes a system memory 1110 and a computer-readable storage media 1122. System memory 1110 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1100, such as during start-up, may typically be stored in the ROM. The RAM typically contains data and/or program modules that are presently being operated and executed by processing subsystem 1104. In some implementations, system memory 1110 may include multiple different types of memory, such as static random access memory (SRAM), dynamic random access memory (DRAM), and the like.

By way of example, and not limitation, as depicted in FIG. 11, system memory 1110 may load application programs 1112 that are being executed, which may include various applications such as Web browsers, mid-tier applications, relational database management systems (RDBMS), etc., program data 1114, and an operating system 1116. By way of example, operating system 1116 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1122 may store programming and data constructs that provide the functionality of some aspects. Computer-readable media 1122 may provide storage of computer-readable instructions, data structures, program modules, and other data for computer system 1100. Software (programs, code modules, instructions) that, when executed by processing subsystem 1104 provides the functionality described above, may be stored in storage subsystem 1118. By way of example, computer-readable storage media 1122 may include non-volatile memory such as a hard disk drive, a magnetic disk drive, an optical disk drive such as a CD ROM, digital video disc (DVD), a Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1118 may also include a computer-readable storage media reader 1120 that can further be connected to computer-readable storage media 1122. Reader 1120 may receive and be configured to read data from a memory device such as a disk, a flash drive, etc.

In certain aspects, computer system 1100 may support virtualization technologies, including but not limited to virtualization of processing and memory resources. For example, computer system 1100 may provide support for executing one or more virtual machines. In certain aspects, computer system 1100 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1100. Accordingly, multiple operating systems may potentially be run concurrently by computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to establish a communication channel to one or more client devices via the Internet for receiving and sending information from and to the client devices. For example, the communications subsystem may be used to transmit a response to a user regarding the inquiry for a chatbot.

Communications subsystem 1124 may support both wired and/or wireless communication protocols. For example, in certain aspects, communications subsystem 1124 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1124 can provide wired network connectivity (e.g., Ethernet) in addition to or instead of a wireless interface.

Communications subsystem 1124 can receive and transmit data in various forms. For example, in some aspects, in addition to other forms, communications subsystem 1124 may receive input communications in the form of structured and/or unstructured data feeds 1126, event streams 1128, event updates 1130, and the like. For example, communications subsystem 1124 may be configured to receive (or send) data feeds 1126 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1124 may be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to communicate data from computer system 1100 to other computer systems or networks. The data may be communicated in various different forms such as structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1100 depicted in FIG. 11 is intended only as a specific example. Many other configurations having more or fewer components than the system depicted in FIG. 11 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

1. A computer-implemented method comprising:
accessing a queue comprising log data items having at least one of one or more characteristics associated with a log index; wherein at least one of the queue's log data items are processed by log processing instances that are configured to process the queue's log data items at least in part by extracting information from the queue's log data items; and wherein sets of information determined from the at least one of the queue's log data items are stored by the log processing instances to first storage shared by the log processing instances;
detecting that log data items are being added to the queue faster than the log processing instances are processing log data items from the queue;
based at least in part on the detecting, activating a separate queue for the log index; wherein one or more other log processing instances are configured to process the separate queue's log data items at least in part by extracting information from the separate queue's log data items;
while the separate queue is active:
adding, to the separate queue for the log index, one or more particular log data items having at least one of the one or more characteristics associated with the log index;
processing, by the one or more other log processing instances, at least one of the one or more particular log data items from the separate queue;
storing, by the one or more other log processing instances, one or more particular sets of information determined from the at least one of the one or more particular log data items to second storage shared by the one or more other log processing instances but not by the one or more log processing instances;
storing an indication that data having at least one of the one or more characteristics is stored across both the first storage and the second storage.

2. The computer-implemented method of claim 1, wherein the first storage is partitioned based on times determined from the at least one of the queue's log data items associated with the sets of information; wherein the second storage is partitioned based on times determined from the at least one of the one or more particular log data items associated with the particular sets of information; the computer-implemented method further comprising:
accessing a request for data corresponding to one or more particular times;
determining, based at least in part on the stored indication, that the first storage covers at least one of the one or more particular times and that the second storage covers at least one of the one or more particular times; and
requesting data from both the first storage and the second storage responsive to the request.

3. The computer-implemented method of claim 1, further comprising:
detecting that log data items are being added to queues, comprising the queue and the separate queue, faster than active log processing instances, comprising the log processing instances and the one or more other log processing instances, are processing log data items from the queues; and
based at least in part on the detecting that log data items are being added to queues faster than active log processing instances are processing log data items from the queues, activating another separate queue to handle part of a load of incoming log data items having at least one of the one or more characteristics associated with the log index.

4. The computer-implemented method of claim 1, further comprising:
detecting that a backlog of unprocessed log data items in the queue has cleared; and
de-activating the separate queue based at least in part on detecting that the backlog of unprocessed log data items in the queue has cleared.

5. The computer-implemented method of claim 1, further comprising:
randomly selecting from among queues comprising the queue and the separate queue for assignment of a new log data item, and
de-activating the separate queue when a length of the separate queue exceeds a threshold.

6. The computer-implemented method of claim 1, further comprising:
determining that a length of a de-activated separate queue satisfies a lower threshold; and, in response, re-activating the de-activated separate queue for processing log data items.

7. The computer-implemented method of claim 1, further comprising:
re-assigning a set of log data items from the queue to the separate queue based at least in part on a length of the queue and a length of the separate queue.

8. The computer-implemented method of claim 1, further comprising determining a number of separate queues to activate based at least in part on a log processing bandwidth and incoming rates of log data items.

9. The computer-implemented method of claim 1, wherein the one or more other log processing instances comprise two or more log processing instances that are further configured to share third storage for log data items that originated before a threshold time; wherein the two or more log processing instances share the second storage for log data items that originated after the threshold time.

10. The computer-implemented method of claim 1, wherein the steps of accessing the queue, detecting that log data items are being added to the queue faster than the log processing instances are processing log data items from the queue, activating the separate queue, adding the particular log data items, processing the particular log data items, storing particular sets of information, and storing the indication are separately performed by a multi-tenant log processing system for each of a plurality of sub-tenant log data partitions of a plurality of tenants of the multi-tenant log processing system; the computer-implemented method further comprising:
accessing a Kafka message for a bundle of log messages corresponding to the log index;
assigning the bundle of log messages to the separate queue;
processing the bundle of log messages from the separate queue; and
storing results of processing the bundle to the second storage; wherein the first storage comprises a first Solr Core Group and the second storage comprises a second Solr Core Group.

11. The computer-implemented method of claim 1, wherein the log processing instances are configured to extract information from the queue's log data items at least in part by parsing the queue's log data items using log parsers selected from a plurality of log parsers based on detected message patterns of a plurality of candidate message patterns;
wherein the one or more other log processing instances are configured to extract information from the separate queue's log data items at least in part by parsing the separate queue's log data items using log parsers selected from a plurality of log parsers based on detected message patterns of a plurality of candidate message patterns.

12. The computer-implemented method of claim 1, wherein the detecting is a second step of detecting, the computer-implemented method further comprising activating at least one of the log processing instances that are configured to process the queue's log data items based at least in part on a first step of detecting that log data items are being added to the queue faster than one or more log processing instances are processing log data items from the queue.

13. A computer-program product comprising one or more non-transitory machine-readable storage media, including stored instructions configured to cause a computing system to perform a set of actions including:
accessing a queue comprising log data items having at least one of one or more characteristics associated with a log index; wherein at least one of the queue's log data items are processed by log processing instances that are configured to process the queue's log data items at least in part by extracting information from the queue's log data items; and wherein sets of information determined from the at least one of the queue's log data items are stored by the log processing instances to first storage shared by the log processing instances;
detecting that log data items are being added to the queue faster than the log processing instances are processing log data items from the queue;
based at least in part on the detecting, activating a separate queue for the log index; wherein one or more other log processing instances are configured to process the separate queue's log data items at least in part by extracting information from the separate queue's log data items;
while the separate queue is active:
adding, to the separate queue for the log index, one or more particular log data items having at least one of the one or more characteristics associated with the log index;
processing, by the one or more other log processing instances, at least one of the one or more particular log data items from the separate queue;
storing, by the one or more other log processing instances, one or more particular sets of information determined from the at least one of the one or more particular log data items to second storage shared by the one or more other log processing instances but not by the one or more log processing instances;
storing an indication that data having at least one of the one or more characteristics is stored across both the first storage and the second storage.

14. The computer-program product of claim 13, wherein the set of actions further includes:
detecting that log data items are being added to queues, comprising the queue and the separate queue, faster than active log processing instances, comprising the log processing instances and the one or more other log processing instances, are processing log data items from the queues; and
based at least in part on the detecting that log data items are being added to queues faster than active log processing instances are processing log data items from the queues, activating another separate queue to handle part of a load of incoming log data items having at least one of the one or more characteristics associated with the log index.

15. The computer-program product of claim 13, wherein the set of actions further includes:
detecting that a backlog of unprocessed log data items in the queue has cleared; and
de-activating the separate queue based at least in part on detecting that the backlog of unprocessed log data items in the queue has cleared.

16. The computer-program product of claim 13, wherein the set of actions further includes:
randomly selecting from among queues comprising the queue and the separate queue for assignment of a new log data item, and
de-activating the separate queue when a length of the separate queue exceeds a threshold;
determining that a length of a de-activated separate queue satisfies a lower threshold; and, in response, re-activating the de-activated separate queue for processing log data items.

17. A system comprising:
one or more processors;
one or more non-transitory computer-readable media storing instructions, which, when executed by the system, cause the system to perform a set of actions including:
accessing a queue comprising log data items having at least one of one or more characteristics associated with a log index; wherein at least one of the queue's log data items are processed by log processing instances that are configured to process the queue's log data items at least in part by extracting information from the queue's log data items; and wherein sets of information determined from the at least one of the queue's log data items are stored by the log processing instances to first storage shared by the log processing instances;
detecting that log data items are being added to the queue faster than the log processing instances are processing log data items from the queue;
based at least in part on the detecting, activating a separate queue for the log index; wherein one or more other log processing instances are configured to process the separate queue's log data items at least in part by extracting information from the separate queue's log data items;
while the separate queue is active:
adding, to the separate queue for the log index, one or more particular log data items having at least one of the one or more characteristics associated with the log index;
processing, by the one or more other log processing instances, at least one of the one or more particular log data items from the separate queue;
storing, by the one or more other log processing instances, one or more particular sets of information determined from the at least one of the one or more particular log data items to second storage shared by the one or more other log processing instances but not by the one or more log processing instances;
storing an indication that data having at least one of the one or more characteristics is stored across both the first storage and the second storage.

18. The system of claim 17, wherein the set of actions further includes:
detecting that log data items are being added to queues, comprising the queue and the separate queue, faster than active log processing instances, comprising the log processing instances and the one or more other log processing instances, are processing log data items from the queues; and
based at least in part on the detecting that log data items are being added to queues faster than active log processing instances are processing log data items from the queues, activating another separate queue to handle part of a load of incoming log data items having at least one of the one or more characteristics associated with the log index.

19. The system of claim 17, wherein the set of actions further includes:
detecting that a backlog of unprocessed log data items in the queue has cleared; and
de-activating the separate queue based at least in part on detecting that the backlog of unprocessed log data items in the queue has cleared.

20. The system of claim 17, wherein the set of actions further includes:
randomly selecting from among queues comprising the queue and the separate queue for assignment of a new log data item, and
de-activating the separate queue when a length of the separate queue exceeds a threshold;
determining that a length of a de-activated separate queue satisfies a lower threshold; and, in response, re-activating the de-activated separate queue for processing log data items.

21. The system of claim 17, wherein the set of actions further includes:
de-activating the separate queue when a length of the separate queue exceeds a threshold;
determining that a length of a de-activated separate queue satisfies a lower threshold; and
in response to the length of the de-activated separate queue satisfying a lower threshold, re-activating the de-activated separate queue for processing log data items.

22. The computer-implemented method of claim 1, further comprising:
de-activating the separate queue when a length of the separate queue exceeds a threshold.

23. The computer-implemented method of claim 22, wherein de-activating the separate queue comprises preventing assignment of additional log data items to the separate queue.
